(19) United States
(12) Patent Application Publication
(10) Pub. No.: US 2026/0254525 A1
(43) Pub. Date: Aug. 27, 2026

(54) Forta Halo – Autonomous Multi-Modal Spherical Energy, Water, and Resilience Apparatus

(71) Applicant: Tysaiah Floyd Franklin, Peculair, MO (US)

(72) Inventor: Tysaiah Floyd Franklin, Peculair, MO (US)

(21) Appl. No.: 19/347,711

(22) Filed: Oct. 2, 2025

Related U.S. Application Data
(60) Provisional application No. 63/869,979, filed on Aug. 25, 2025.

(51) Int. Cl. H04B 7/185; H02J 50/00

(52) U.S. Cl. CPC H04B 7/18504; H02J 50/001

(57) ABSTRACT

A distributed airborne system configured to harvest environmental energy, manage power conversion, and support communication or grid-interaction functions. Each airborne node comprises a spherical or semi-spherical aerostructure incorporating multi-modal energy-harvesting surfaces, internal kinetic-capture assemblies, and an energy-conditioning module that stabilizes output for delivery to designated receivers. A stabilization framework enables adaptive response to variable atmospheric conditions while maintaining controlled positioning. The nodes form a coordinated airborne layer governed by an autonomous control module that analyzes environmental inputs, operational demands, and network conditions to allocate resources and adjust node behavior. The system operates independently or in cooperation with terrestrial infrastructure and is capable of supporting resilience, energy distribution, and communication roles through dynamic airborne deployment.

### CROSS-REFERENCE TO RELATED APPLICATIONS

This application claims priority to U.S. Provisional Patent Application No. 63/869,979, filed Aug. 25, 2025, entitled “Forta Halo.” This application also references U.S. Provisional Patent Application No. 63/871,500, filed Aug. 26, 2025, entitled “Forta Vault (Storage).” Additionally, it is related to U.S. NonProvisional patent application Ser. No. 19/328,145, filed Sep. 13, 2025, entitled “Forta Nexus” (distributed orchestration engine). Each of these applications is incorporated by reference herein in its entirety.

### FIELD OF THE INVENTION

The present invention relates to renewable energy systems, telecommunications infrastructure, climate resilience technologies, and distributed autonomous networks. More particularly, it concerns an autonomous buoyant airborne platform capable of: (i) multi-modal energy harvesting across wind, solar; thermal, kinetic (precipitation), and storm domains; (ii) wireless communications and broadcasting (including Wi-Fi, cellular/6G, satellite, and mesh networking); (iii) climate and resource functions such as atmospheric water harvesting and carbon capture; and (iv) secure autonomous redistribution of resources to distributed storage networks-all while maintaining continuous integration with existing power grids and communication infrastructure.

### BACKGROUND OF THE INVENTION

Conventional renewable infrastructure remains limited by single-mode operation and fixed locations. For example, wind farms are ineffective without sustained winds, and solar farms become inert at night or under storm conditions. Communications towers and high-altitude telecom balloons can provide connectivity but do not contribute to energy generation or environmental management. These systems generally cannot adapt dynamically to extreme weather; and they lack integrated multi-modal capabilities.

Moreover; existing solutions do not offer seamless integration with legacy grids or any mechanism for autonomous background resource redistribution. For instance, a wind turbine cannot automatically store excess energy elsewhere without human intervention, and drones or tethered balloons typically require direct control and lack robust fail-safes. Security is another concern: prior art in aerial networks has not addressed the emerging threat of quantum computer attacks on communications, leaving data links potentially vulnerable.

In summary, current technologies do not combine energy harvesting, climate intervention, resilient networking, and autonomous resource management in a single aerial platform. The Forta Halo addresses these gaps by unifying multiple functionalities with autonomous AI control and secure protocols, as described below. Novelty No prior art discloses a buoyant airborne apparatus that (1) unifies multi-modal energy harvesting across numerous environmental sources, (2) integrates a sovereign onboard AI for fallback autonomous operation, (3) performs autonomous chain-transfer of resources among networked units, and (4) maintains seamless output to existing infrastructure while performing encrypted background offloads of surplus resources. In contrast to known systems, the Forta Halo provides all of these capabilities in one platform. It is a storm-hardened spherical unit that concurrently serves as an energy harvester, communication node, and climate responder-all under a unified autonomous control system.

This combination of features forms a resilient airborne infrastructure layer unprecedented in scope, bridging multiple technological domains in a novel way. (Prior art examples include high-altitude balloon relays such as Alphabet Loan, airborne wind systems like Makani kites, triboelectric rain energy harvesters, ambient RF scavengers, atmospheric water generators, etc., each addressing fragments of this space but none suggesting the fully integrated system of the present invention.)

### SUMMARY OF THE INVENTION

Forta Halo is a buoyant, autonomous spherical apparatus comprising a multi-layer composite shell with adaptive self-healing materials for durability and triple-mode buoyancy control (e.g., helium or hydrogen lift cells, controllable heated air, and electromagnetic stabilization). The Halo simultaneously harvests multiple forms of environmental energy-including wind, solar, thermal gradients, precipitation, and lightning/storm power-through dedicated subsystems. It also provides integrated wireless communication capabilities (software-defined radios supporting WiFi, 5G/6G cellular, satellite links, and mesh networking) with dynamic spectrum allocation and edge computing resources (onboard micro-VMs for local data processing or streaming).

Each Halo unit includes climate and resource modules for atmospheric water harvesting and carbon capture, with extensions for cloud seeding (with a remotely actuable kill-switch for safety), urban heat mitigation via dispersal of reflective nano-films, and wildfire suppression via mist nozzles or water payload release. These climate-related and environmental resilience modules are optional and non-essential embodiments, provided solely to demonstrate potential extensions of the system's adaptability. They are not part of the core inventive concept, which resides primarily in the integrated synergy between multi-modal energy harvesting, buoyancy regulation, and secure encrypted redistribution. The inclusion of such modules is intended to illustrate the versatility of the apparatus in various operational environments and should not be construed as defining independent inventive subject matter. Surplus energy or collected resources are automatically offloaded using an autonomous encrypted background handshake protocol over optical, inductive, or microwave channels, configured for autonomous transfer to distributed secure storage nades (“Forta Vault” units), executed without disrupting the Halo's primary power or communication services. Halos can operate individually or in coordinated swarms. In a swarm deployment, units communicate over quantum-resistant secure links and share loads; they can perform chain-transfer of energy or water between one another to balance resources.

The system can be orchestrated by an optional centralized Nexus AI engine, but each Halo has a sovereign onboard control that enables fallback autonomous operation if externa! network support is lost. The Halo is further designed for dual-mode operation: it can function as a freeroaming energy harvester or be recalled to act as a stationary “harvester hub” (for example, returning to a base station or tether point to inject power into the grid or to undergo maintenance). By combining multi-modal harvesting, buoyant lift control, and encrypted resource redistribution, the Forta Halo provides a robust, self-optimizing infrastructure element that addresses the shortcomings of prior solutions. Notably, the Halo can leverage storm electrical energy (e.g. lightning strikes) to produce hydrogen gas via onboard electrolysis for additional lift or fuel, exemplifying the system's synergistic use of harvested resources. Furthermore, all background offloads of energy, water, or data occur without interrupting the Halo's foreground power delivery or communication functions, ensuring continuous primary services even during autonomous resource redistribution.

### BRIEF DESCRIPTION OF THE DRAWINGS

FIG. 1: Structural cutaway of a Halo unit (related to the apparatus of claim 1), illustrating the layered spherical shell construction (with self-healing outer layer), interna! buoyancy control cells, placement of energy harvesters, and the central AI control core. (FIG. 1 is a cutaway view of a conceptual spherical Halo, showing the multi-layer she/1 (1) with self-healing material and interna/ gas lift ce/ls (2), various integrated energy harvesters such as wind turbines and photovoltaic panels (3), and a central control/AI core (4). These correspond to structural features of the claimed apparatus.)

FIG. 2: Multi-modal energy harvesting subsystems (supporting various dependent claims on energy sources), including the distribution of transparent photovoltaic skin panels, interna! micro wind turbines with venturi channels and adaptive blades, thermoelectric/Stirling converters, piezoelectric and triboelectric layers for rain energy capture, and conductive elements for lightning and ambient RF collection.

FIG. 3: Additionally illustrates the energy routing path feeding the hydrogen buoyancy subsystem shown in FIG. 2. Communications and computation subsystem architecture, showing software-defined radio modules, Wi-Fi/cellular transceivers, satellite communication links, broadcast antennas, and mesh networking links between Halo units. Also depicted are the edge computing modules (microprocessors/VMs) enabling local data processing and dynamic spectrum management (as recited in the communications subsystem features of certain claims).

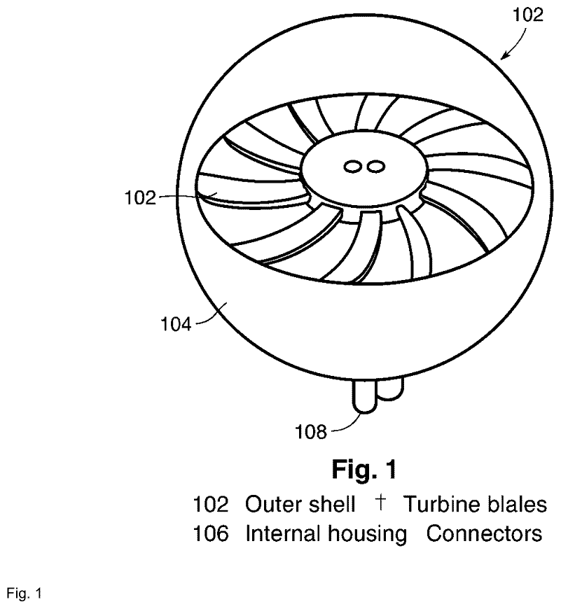

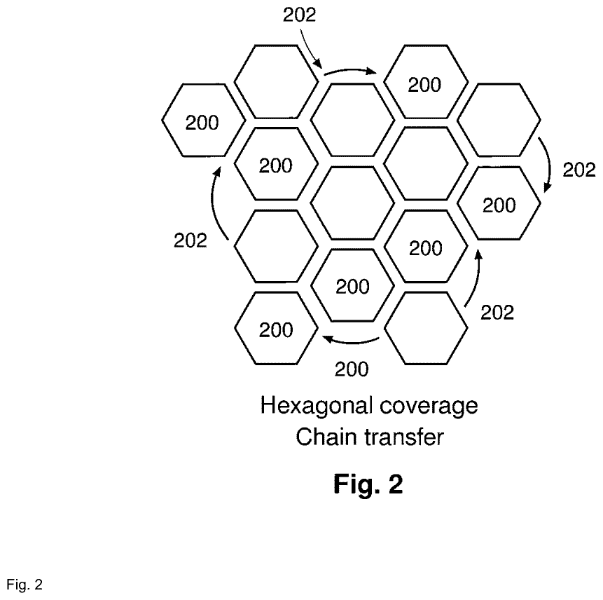

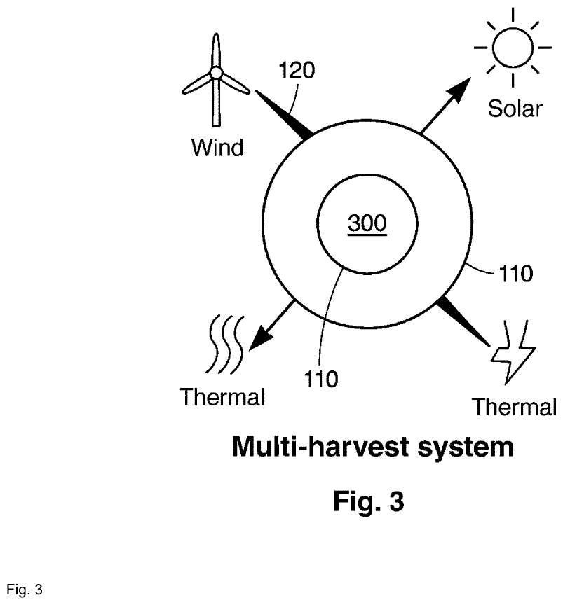

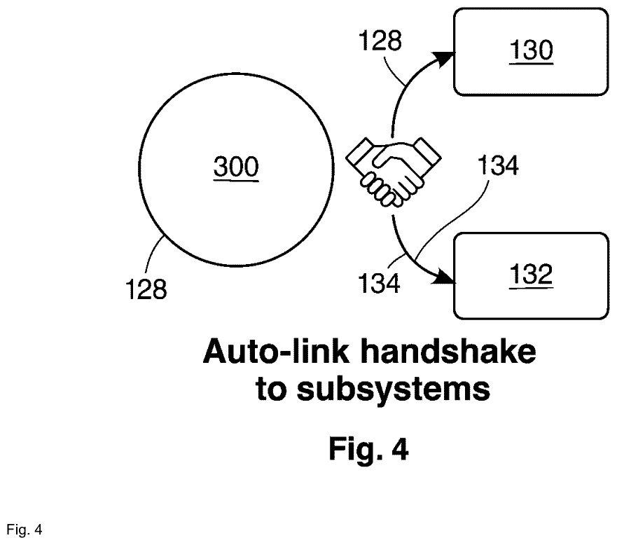

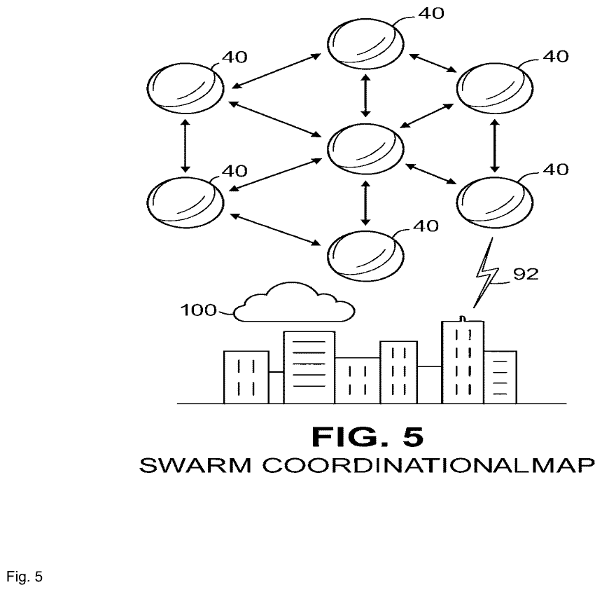

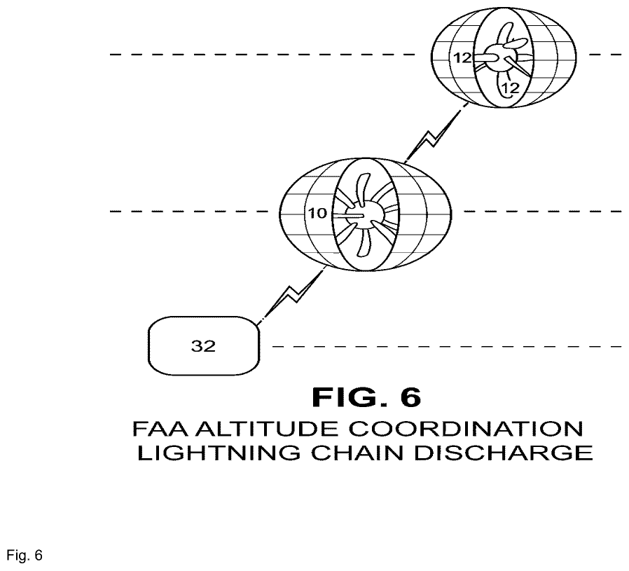

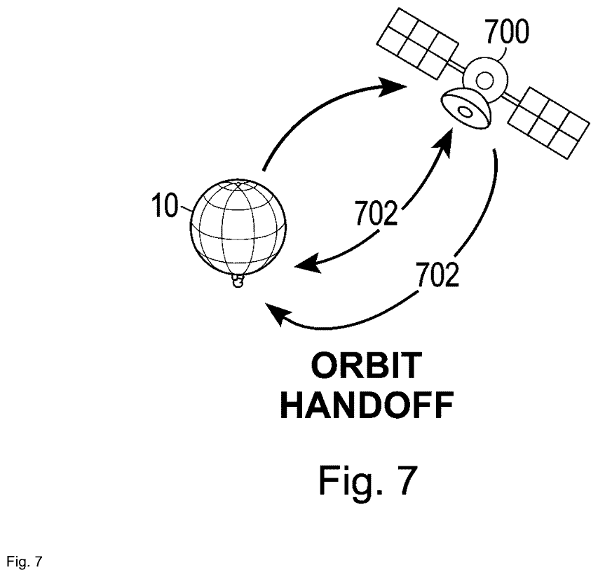

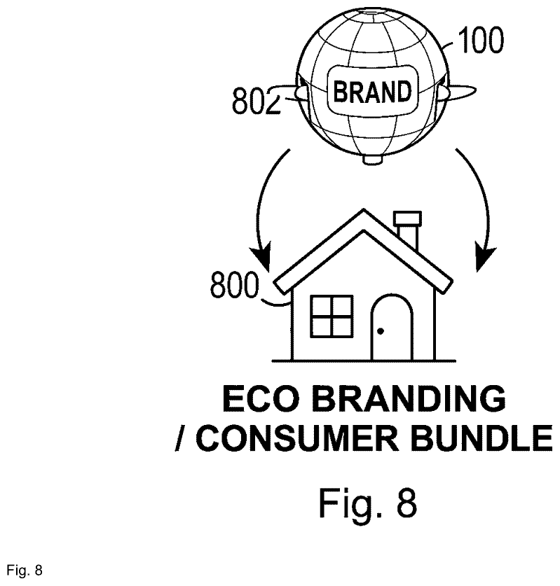

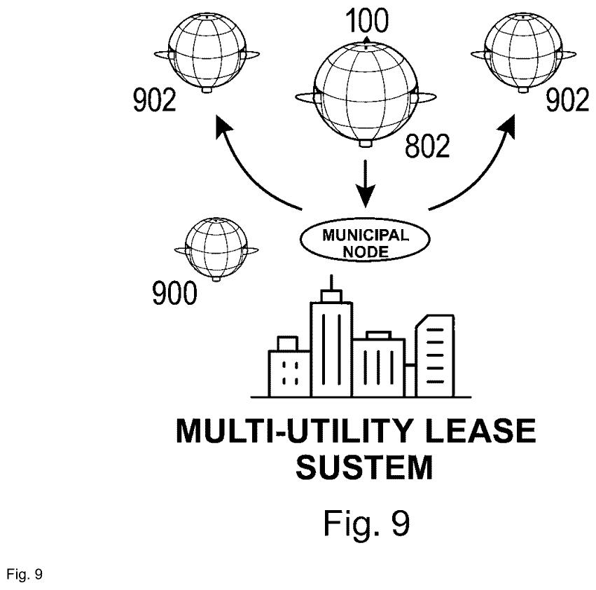

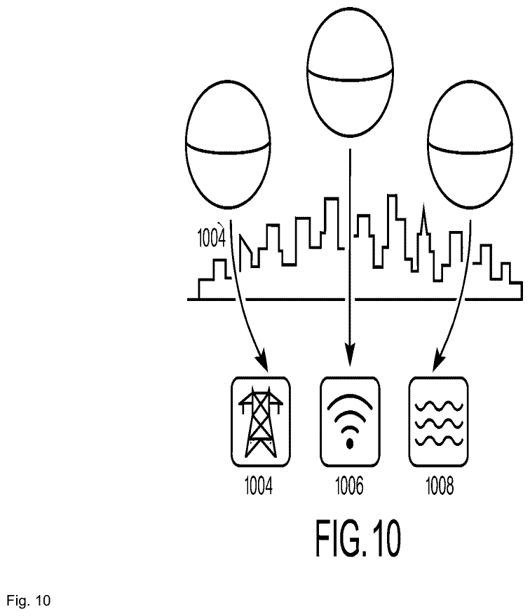

In one embodiment, the harvested energy from high-voltage atmospheric events, such as lightning discharges, is routed through a high-energy regulator and isolation circuit to ensure safe and controlled conversion before entering the buoyancy subsystem. As illustrated in FIG. 2 and FIG. 3, the output from the ultracapacitor bank (rated between 10-10 joules) is fed to a hydrogen generation module equipped with pressure sensors, current limiters, and recombination valves. A dedicated data bus and control logic manage this transfer, monitoring voltage thresholds, capacitor state-of-charge, and gas pressure in real time. The process is supervised by the onboard AI control system, which dynamically allocates surplus electrical energy to either buoyancy maintenance or storage redistribution depending on environmental and operational parameters.

FIG. 4: Climate and resource subsystem diagram, detailing an atmospheric water harvesting unit (e.g., a MOF-based or desiccant air-to-water collector with radiative cooling surfaces), a carbon dioxide capture module (with optional catalytic converters to synthesize fuels), cloudseeding dispersa! nozzles (with a remate kili-switch), deployable reflective film layers for urban cooling, and a wildfire suppression system (such as water/mist spray nozzles and detachable water capsules). (These features correspond to aspects of the climate adaptation subsystems in the claims.)

FIG. 5: Encrypted autonomous handshake interface to the Forta Vault distributed secure storage network. This illustration shows the optical or inductive handshake mechanism between a Halo and a ground storage node, the secure lattice-based encryption key exchange (postquantum cryptography for authentication), and a timing diagram of the encrypted background handshake protocol. The timing diagram demonstrates that energy/data packets are transferred in parallel to the Halo's primary operations without interruption (supporting the resource offloading described in claim 1). The term “autonomous encrypted handshake protocol” refers to a structured sequence of communication steps—including initiation, authentication, key exchange, encrypted data transfer, confirmation, and termination—executed automatically by the onboard PQC module. The protocol operates at frequencies of 50-500 kHz for inductive transfer, or 24-60 GHz for microwave transfer, 3and maintains a total handshake latency below 20 milliseconds to support real-time swarm coordination.

FIG. 6: Swarm coordination and chain-transfer scenario-multiple Halos in a network demonstrating resource hand-off (e.g. a directed wireless energy beam, inductive power transfer, or physical swapping of resource pods) from one unit to another, and the repositioning of neighboring units to cover for a unit that goes offline or enters recall mode. (This scenario corresponds to the swarm behaviors and inter-unit transfer features described in the claims.) The expression “swarm-level coordination” refers to the RF mesh and infrared (IR) relay network interconnecting multiple airborne units within a range of 1-5 kilometers. Each apparatus exchanges telemetry packets every 5 seconds through secure PQC channels, enabling coordinated flight paths, energy balancing, and predictive recall operations inadverse weather conditions.

FIG. 7: Recall and redeployment sequence-a Halo unit autonomously descending to a base station or safe zone ahead of a severe storm (recall mode) and then, after the storm, ascending and navigating back to an optimized position (redeployment) as computed by either its own AI or the Nexus system.

The figure highlights the telemetry sent to the Nexus during these events for compliance and optimization. Additionally, the figure labels the Halo's hydrogen overpressure relief valve and its catalytic recombiner unit, illustrating the built-in safety features for hydrogen buoyancy control during emergency descent. (These features relate to the dual-mode operation and autonomous rec aspects of the claimed system.)

FIG. 8: Edge computing and payload bay usage-interna! diagram showing modular payload bays and an example plug-in module (such as a sensor suite or medical supply pod). The figure also shows an edge computing module analyzing camera data and streaming results, demonstrating on-board inference capabilities. FIG. 8 illustrates optional embodiments related to environmental resilience and is not part of the core inventive scope defined in the main claims

FIG. 9: Quantum-safe communications hardware and EMP hardening features-cross-sectional detail indicating a dedicated post-quantum cryptographic (PQC) encryption module within the Halo's communication system (depicting data flow through a quantum-resistant encryption chipset), along with a Faraday-cage enclosure around critica! electronics, grounding paths and surge arrestors (including a shunt to supercapacitors) to dissipate electromagnetic pulse energy, and shielding layers integrated into the shell. The “predictive AI routines” implemented within the onboard control system process historical telemetry, weather data, and real-time energy load information to forecast environmental and operational changes. Based on these inputs, the AI adjusts harvesting efficiency, buoyancy pressure, and swarm positioning to optimize system stability and energy output.

FIG. 10: Schematic of the legacy integration and compliance system-including a tether interface for grid connection (with an example medium-voltage DC converter), the Halo's ADS-B transponder and collision-avoidance sensors working to meet aviation regulations, and the telemetry link to the Nexus AI for reporting status and receiving optimization instructions. (These elements relate to the tethering interface and compliance features described in the claims.)

### DETAILED DESCRIPTION OF THE INVENTION

The Forta Halo system comprises a multi-layer spherical structure engineered for buoyancy control, multi-modal energy harvesting, secure communications, and autonomous swarm operation. In the preferred embodiment, the Halo's outer shell is a composite material (for example, a graphene-reinforced polymer)that is adaptive and self-healing. Minor punctures or tears in the shell material autonomously seal (e.g., via embedded microcapsules of resin or thermally activated sealant) to maintain structural integrity. This robust shell, along with interna! buoyant gas cells and an optional electric/magnetic stabilization system, provides triple-mode lift: buoyancy from a lighter-than-air gas (such as helium, which can be supplemented or replaced by onboard-generated hydrogen in sorne modes), buoyancy from heating interna! air, and active stabilization or thrust from electromagnetic interactions (for instance, ion propulsion units or magnetic flux modulation against Earth's magnetic field). The result is a highly stable platform that can adjust altitude and position even in turbulent conditions, and quickly recover from damage or punctures.

For embodiments utilizing hydrogen as a lifting gas (produced via an onboard water electrolyzer), the Halo incorporates multiple safety mechanisms to enable hydrogen use without undue risk. Interna! gas cells are designed to operate at pressures only slightly above ambient (on the order of a few PSI above atmospheric pressure), with overpressure relief valves and burst discs that automatically vent gas at predefined safe limits.

Passive catalytic recombiner elements are integrated inside the gas cells to continuously convert any leaked hydrogen and oxygen back into water, preventing flammable gas buildup. If internal pressure exceeds a safe threshold (for example, beyond approximately 1.2 atm absolute), the relief valves vent hydrogen to the atmosphere to avert structural rupture or explosion. A network of sensors and interlocks ties the hydrogen generation system to gas leak detectors; if any hydrogen leakage or unsafe concentration is detected, the control system automatically halts hydrogen production, electrically grounds the apparatus, and vents hydrogen in a controlled manner. In emergency scenarios (for instance, if there is fire risk or a need for rapid descent), the Halo can jettison hydrogen gas quickly to eliminate lift and remove flammable material. These features ensure that using hydrogen for buoyancy is practical and controlled, enabling the benefits of hydrogen lift while mitigating associated hazards.

Embedded throughout the Halo are multiple energy harvesting subsystems operating in parallel, each tuned to a different environmental energy source:
Wind Energy Harvesting: The Halo includes venturi-effect wind inlets that drive interna! microturbines with adaptive blades. As air flows through channelized ducts in the spherical body, it spins these turbines. The blade assemblies can adjust pitch or deploy/retract to optimize energy capture from varying wind speeds. This subsystem allows continuous wind power generation whether the Halo is stationary or drifting in air currents. For example, even at moderate wind speeds (~5-1O mis), the microturbines can produce meaningful power (tens to hundreds of watts), while in strong winds (>20 m/s), venturi augmentation and blade adjustments enable generation on the order of kilowatts. The system is designed to survive extreme gusts by feathering or retracting blades as needed for protection.
Solar Energy Harvesting: The outer surface of the shell is laminated with a transparent photovoltaic skin (e.g., a flexible thin-film solar cell layer). This skin captures sunlight from all angles (omnidirectional coverage) while still allowing light to pass through to any interna! systems that need illumination.

Beneath or integrated with the PV layer; a graphene-based transparent conductive layer may be incorporated; this layer adds structural strength and aids self-healing while also serving as an electrode for the solar cells. Solar energy is collected and either used in real-time to power onboard systems or stored in high-density batteries and supercapacitors inside the Halo. In one embodiment, the PV skin has a conversion efficiency of approximately 20-35%. On a spherical surface area of tens of square meters (depending on Halo size), this yields up to tens of kilowatts of power under full sun. For instance, a 5-meter diameter Halo (surface orea ~78 m2) at 25% efficiency could generate on the order of 15-25 KW of electrical power in direct sunlight. The system includes maximum power point tracking (MPPT) circuitry to optimize solar energy harvest throughout the day.

Thermal Energy Harvesting: The Halo employs thermoelectric generators (TEGs) and/or a miniaturized Organic Rankine Cycle (ORC) turbine to exploit temperature differences. For example, at higher altitudes the air is cooler; the Halo can absorb heat from sun-exposed surfaces or from interna! electronics and convert that thermal gradient into electricity via the TEG modules. In sorne embodiments, a small Stirling engine cycles between sun-warmed gas and cooler shaded areas to produce mechanical power. Waste heat from electronic components is also captured and fed into this thermal harvesting subsystem, ensuring energy is gleaned from temperature fluctuations and would-be waste heat. Typical TEG modules can generate tens of millivolts per degree Celsius of temperature differential; with a well-insulated design the Halo could maintain a gradient of tens of ° C. between an internal heat reservoir and the cooler externa! atmosphere, yielding a continuous trickle of power from thermal cycling.
Precipitation & Kinetic Energy Harvesting: The Halo's exterior is coated or sectioned with piezoelectric and triboelectric materials that generate power from mechanical impacts and vibrations. Raindrops, hail, or even dust and sand particles striking the shell induce small electrical charges. Rainfall thus becomes a source of kinetic energy: each droplet's impact on a piezoelectric patch produces a charge that is collected via conditioning circuits (e.g., rectifiers and charge pumps) and fed into the power bus or storage elements. Additionally, slight vibrations of the Halo's structure (caused by wind buffeting or movement) are captured by these same or dedicated vibration-harvesting elements, turning structural oscillations into electrical energy. This system not only generates power in rainy conditions but also helps dampen vibrations, contributing to the platform's stability. For example, polyvinylidene difluoride (PVDF) piezo strips on the shell can produce bursts of charge on the order of microcoulombs per raindrop impact; in a heavy rainstorm, this equates to several watts of sustained power. Hail or strong wind-induced oscillations produce larger deflections and higher outputs, ali of which are scavenged and stored.
Storm Electrical Energy Harvesting: In stormy conditions, the Halo can harvest intense environmental electrical energy. It is equipped with conductive lightning capture rods or electrodes protruding from (or embedded in) the shell to intercept lightning strikes. These are safely channeled into onboard energy storage, such as a bank of high-capacity ultracapacitors. The power management system includes multi-level surge suppression: spark gap arrestors and plasma diverters route the initial surge, followed by transient voltage suppressor (TVS) diodes and fast-acting fuses that isolate sensitive circuits if a surge exceeds design limits. A lightning strike's energy is temporarily shunted into the ultracapacitor array, which is capable of handling extreme currents (e.g., tens of kiloamps) and storing pulses on the order of 1QAS-10′″6 joules. The stored charge is then metered out through high-power DC-DC converters into the main batteries or directly to heavy loads (for instance, powering the onboard electrolyzer to generate hydrogen fuel immediately after a strike). Additionally, an inductive coil or magneto-electric converter is integrated to scavenge ambient electromagnetic field energy present in the environment (including man-made RF signals and natural atmospheric electric fields). This means that even without a direct lightning strike, the Halo can collect energy from strong electric fields (for example, within charged cloud regions or in proximity to high-voltage power lines). Overall, the storm harvesting subsystem not only allows the Halo to survive direct lightning hits but also to utilize them—turning a hazardous event into a useful power source. Design safeguards ensure the Halo's frame and electronics are protected during such events: critica! components are enclosed in Faraday-cage shielding, and the shell incorporates conductive meshes to distribute currents. In sorne embodiments, grounding tethers or long trailing discharge lines may be deployed to safely dissipate excess charge after a strike. Beyond energy, the Forta Halo carries climate and resource subsystems that actively collect resources and intervene in environmental conditions:
Atmospheric Water Harvesting: Each Halo can pull moisture from the air. For example, a desiccant or metal-organic framework (MOF) based water collector is integrated, possibly with radiative or evaporative cooling surfaces to aid condensation. Air is drawn into the unit via small fans and passed over a hygroscopic material (such as a MOF-801 powder or a silica gel bed), where moisture is adsorbed. Periodically, the material is heated (using waste heat or solar thermal input) to release the collected moisture, which then condenses in a storage chamber as liquid water. In one embodiment, a Halo can collect on the order of several liters of water per day in humid conditions. The stored water serves multiple purposes: it provides drinking water in humanitarian or remote deployments, supplies the wildfire suppression system, and/or feeds into the Halo's electrolyzer to produce hydrogen gas for buoyancy or fuel.
Carbon Dioxide Capture: An atmospheric carbon capture module is integrated into the apparatus, using chemical sorbents or selective membranes to extract CO2 from ambient air as the Halo operates. For example, an amine-functionalized sorbent can absorb CO2 when air is blown over it; later; when heated or exposed to vacuum, it releases concentrated CO2 that can be collected. Optionally, a catalytic converter module can combine the captured carbon (and possibly sorne of the hydrogen from water electrolysis) into hydrocarbon fuels or other useful compounds. For instance, using a Sabatier reaction or Fischer-Tropsch process, CO2 and H2 could be converted into methane or liquid fuel onboard in small quantities. The primary goal of this subsystem, however; is carbon removal: each Halo can gradually scrub CO2 from the air; effectively reducing greenhouse gas concentration over its patrol area. Although each unit's carbon capture capacity might be modest (e.g., tens of grams of CO2 per day depending on airflow and sorbent capacity), a large network of Halos could collectively sequester significant amounts or even synthesize measurable fuel reserves over time.
Cloud Seeding and Climate Intervention: The Halo can optionally carry cloud-seeding dispersal nozzles to induce precipitation in targeted clouds. It can release microscopic particles such as silver iodide or other hygroscopic salts that act as cloud condensation nuclei. Each seeding module is equipped with a remotely actuable kili-switch that can instantly halt dispersa! or neutralize the agents if conditions become unsafe or if an abort command is issued (ensuring regulatory compliance and precise control over weather modification efforts). For urban heat island mitigation, the Halo can deploy reflective nano-film strips or aerosol particulates at altitude, creating a temporary increase in local albedo that reflects a portian of solar radiation away and cools the area below. As with cloud seeding, these dispersals have safety interlocks to prevent overuse or accidental misdeployment.
Wildfire Detection and Suppression: Equipped with thermal and optical sensors, the Halo can detect emerging wildfires or hotspots on the ground. In response, a wildfire suppression system can be activated. Each Halo may carry a payload of water or fire retardant (possibly water harvested from the atmosphere, or delivered from ground storage) in detachable capsules or via on-board spray nozzles.

When a wildfire is detected below, the Halo can autonomously descend to a lower altitude and release a fine mist or perform a targeted water/retardant drop over the coordinates to help douse the flames or slow the fire's spread. If multiple Halos are present, they can coordinate to encircle and attack a fire from multiple angles. Although each unit's payload is limited (for instance, a Halo might carry 10-50 liters of water or retardant), precision deployment and swarm coordination maximize the effectiveness of these interventions.

All harvested surplus energy and collected resources (e.g., excess electricity, water; or data) are managed by the onboard control system and offloaded autonomously. Surpluses are automatically transferred using the encrypted, low-profile background handshake protocol to designated Forta Vault storage nodes or other Halos acting as storage relays. This offloading happens as a background process so as not to interrupt the Halo's primary operations. For example, when the Halo's batteries approach full charge or it accumulates more water than needed, it will establish a discreet link with a nearby Vault unit (either a ground station or another Halo configured as a vault). Using a quantum-resistant key exchange (e.g., lattice-based post-quantum cryptographic algorithms for authentication), the Halo securely handshakes and initiates a transfer. Excess energy can be beamed via a focused microwave to the Vault's rectenna or siphoned through inductive resonance if the Halo is docked nearby; similarly, data packets (such as telemetry logs or sensor recordings) are uplinked for archiva! storage; water or other physical resources can be offloaded by dropping sealed capsules to a Vault drone or pumping through a tether if one is connected. The handshake protocol is designed to be lowprofile, emitting minimal detectable radiation and blending with background noise to avoid drawing attention—effectively a “silent” data/energy handoff. Routing logic in the Halo's AI ensures that resources are sent to optimal locations (far instance, extra energy is directed to a Vault battery bank that is low on charge, or excess water to a Halo that needs it) based on the network-wide status. All transfers are secured end-to-end with post-quantum cryptographic (PQC) authentication to prevent malicious interception or spoofing. Importantly, these background offloads occur without disrupting the Halo's primary power supply or communication services-the unit continues its main functions (e.g., supplying steady power to the grid or maintaining user communication coverage) while the excess resource transfer happens in parallel as a background task.

The onboard control system and AI orchestrate all of the above functionalities. Each Halo is governed by an integrated computer system that includes sensors, actuators, and a machine learning or rule-based AI engine. This AI handles real-time decision-making far navigation, energy management, and local operations.

For example, the AI decides when to perform electrolysis (if power is in excess), when to deploy climate intervention measures, or how to adjust turbine blade angles far maximum output. It also monitors structural and system health, using embedded sensors in the shell to detect punctures or strain and triggering self-healing responses or maintenance routines as needed. The AI can predict component failures by analyzing sensor data trends or performance degradation (predictive maintenance), and it can reconfigure or shut down components preemptively before they fail. Critically, this onboard intelligence enables fully sovereign operation: each Halo can operate autonomously far extended periods without ground control. If network connectivity to the Nexus orchestration AI is lost, the Halo's local AI will continue executing its mission and safety protocols, effectively entering a fallback mode where it relies on pre-loaded objectives and on-board sensor inputs to make decisions.

When multiple Halos are deployed as a swarm, they continuously communicate and coordinate with each other. Each unit's communications subsystem (with its software-defined radios) supports a wide range of frequencies and can perform dynamic spectrum allocation. In practice, Halos might use high-frequency bands (e.g., mmWave) far short-range inter-Halo mesh links and lower-frequency bands far long-range communication to ground stations or user devices, switching channels on the fly to minimize interference and maximize throughput. All inter-Halo and Halo-to-ground links are secured with quantum-safe encryption. The system implements lattice-based post-quantum cryptographic algorithms (such as NIST—recommended CRYSTALS-Kyber far key exchange and Dilithium far signatures) far every communication channel. A dedicated post-quantum cryptographic chipset or FPGA module on each Halo handles this encryption/decryption efficiently in hardware, ensuring that even resourceconstrained airborne units maintain secure links. As a result, even a future quantum computer adversary would be unable to decipher the Halo's communications, protecting control commands, telemetry, and transferred data. Each Halo thus maintains quantum-resistant swarm links and secure channels to Nexus or any cooperating infrastructure.

Beyond communications, the Halos serve as edge computing nodes. They house processing units and memory that allow them to run microservices or virtual machines on-board. Far instance, a Halo could cache popular internet content to serve nearby users with low latency, perform AI inference on sensor data (such as analyzing imagery far disaster response or environmental monitoring), or host emergency communication services in a grid-down scenario. These edge computing tasks can operate independently or in coordination with ground networks, extending cloud capabilities to the airborne network edge.

Safety and regulatory compliance are integral to the Halo's design. Each unit is equipped with an array of sensors and fail-safes far collision avoidance and airspace compliance. A combination of radar; LiDAR, optical cameras, and an ADS-B transponder/receiver allow the Halo to detect and track nearby aircraft or obstacles and automatically maneuver to avoid collisions. The system respects geofencing rules and altitude limits; for example, it can automatically descend or move if it approaches a restricted airspace or if directed by air traffic control signals. The Halo continuously transmits telemetry data (identity, position, altitude, system health, etc.) to the Nexus orto appropriate authorities, forming a compliance data stream. This ensures transparency and safe integration into civilian airspace-each Halo essentially behaves like a well-monitored unmanned balloon or UAV that adheres to aviation regulations, making it easier to obtain flight clearance.

Additionally, Halos can employ adaptive camouflage or visibility settings: the exterior may include panels that change color or reflectivity to blend with the sky, and dimmable lights to avoid contributing to light pollution at night (while still remaining visible enough to aircraft as required). In sensitive deployments, a Halo could minimize its radar signature or lighting to avoid drawing attention, all without affecting its energy harvesting and communication functions.

Swarm coordination and autonomous recall: In deployment, multiple Halos work as a collaborative network. They share data about weather; local energy demand, and their operational status. If a severe weather event (e.g., a hurricane) is approaching, the swarm intelligence (either distributed among the Halos or via Nexus guidance) can trigger a swarm recall-units in the affected region will autonomously navigate to safe locations (for example, moving out of the storm's path or descending to ground stations or lower altitudes where conditions are safer). During such a retreat, Halos enter a protective mode (securing turbines, retracting sensitive antennas, etc.). After the event passes, the Halos redeploy: they return to their designated service areas or adjust to new optimal positions. The Nexus AI or the Halos' onboard Als recalculate the ideal distribution of units (sorne may reposition to cover for any unit that was damaged, or to adapt to post-disaster needs such as focusing more units on an area that lost grid power). This post-event re-optimization ensures continuity of service. Notably, even if externa! communication is down during a disaster; the Halos' fallback autonomy means they can still make recall and redeployment decisions on their own using pre-set criteria(for example, if wind speeds exceed a safe threshold or if they detect the loss of neighboring units for a certain duration, they will seek shelter and later fan out again when conditions improve).

Throughout all operations, each Halo produces and logs a wealth of data-energy generated, energy used, resources collected, subsystem status, position, etc. This data is included in the compliance telemetry and AI optimization reports sent to Nexus or another control center. The Nexus AI uses this information to refine strategies (such as adjusting swarm formation, tweaking algorithms for energy allocation, or scheduling maintenance). The telemetry also provides an audit trail to demonstrate that the Halo network is operating within prescribed safety and regulatory parameters (e.g., altitude limits, emission levels, communication frequencies), addressing any concerns from authorities or clients. If any anomaly or deviation is detected, the system can alert human operators or automatically take corrective action.

In sum, the Forta Halo is a multi-faceted airborne platform that combines energy harvesting, resource collection, communications, and autonomous intelligent control in a single spherical vehicle. The synergies between these functions-for example, using excess energy to produce hydrogen for lift, using secure communications to coordinate energy sharing among units, or performing climate interventions without disrupting grid services-are core to the invention's novelty. This integrated approach yields a resilient infrastructure element capable of addressing power; connectivity, and environmental challenges in a unified manner. The following claims delineate various novel aspects of the Forta Halo.

### Definitions and Terminology Clarifications

For purposes of clarity and consistency within this specification, certain terms used throughout the description are defined as follows:
“Low-profile encrypted channel” refers to a transmission link operating below an optical output of 1 watt or an inductive field strength below 0 dBm, designed to minimize detectability while maintaining secure data throughput.
“Chain-transfer system” refers to the sequential redistribution of energy, water, or data between multiple airborne units within a swarm, where resources are passed node-to-node under encrypted control protocols.
“Distributed secure storage infrastructure” denotes a network of encrypted offload nodes configured to receive, store, and replicate surplus energy or data packets transmitted from the airborne apparatus via infrared, inductive, or microwave channels.
“Predictive AI routines” are defined as machine learning algorithms or heuristic models implemented within the onboard control processor, capable of forecasting atmospheric or operational conditions based on historical telemetry and environmental inputs to adjust flight, buoyancy, and harvesting parameters autonomously. These definitions are intended to provide technical clarity and ensure that the terms are construed consistently throughout this specification.

### Independent Claims

1. An autonomous aerial service node, comprising: (a) a buoyant airborne structure configured for sustained station-keeping without reliance on terrestrial power, cabling, or fixed foundations; (b) an environmentally coupled energy synthesis assembly configured to derive operational power from a plurality of concurrent ambient inputs; (c) a service continuity bus configured to allocate synthesized energy among propulsion, control, communications, storage, or external delivery functions; and (d) a sovereign control engine configured to coordinate energy synthesis, service delivery, and positional stability such that the node performs one or more infrastructure-grade service functions continuously in the absence of ground-based support systems.
2. The aerial service node of claim 1, wherein the environmentally coupled energy synthesis assembly comprises a plurality of dissimilar transduction domains operating concurrently to convert ambient environmental phenomena into electrical power, the domains including:
a. a radiative conversion domain;
b. a fluid-dynamic kinetic conversion domain;
c. a thermal-gradient conversion domain; and
d. a mechanically induced charge conversion domain; wherein coordinated operation of the domains enables continuous power availability across variable environmental conditions.
3. The aerial service node of claim 1, further comprising a distributed service arbitration subsystem configured to manage bidirectional information exchange between the node and external endpoints, wherein the subsystem dynamically governs routing, prioritization, continuity, and reassignment of information flows based on an operational state of the node and a surrounding service environment.
4. A distributed aerial service fabric, comprising a plurality of aerial service nodes according to claim 1, wherein each node exchanges operational state information with at least one other node and autonomously adjusts service responsibility, positioning, or load allocation to preserve uninterrupted service delivery upon degradation, relocation, or loss of an individual node. Dependent Claims
5. The aerial service node of claim 1, wherein the buoyant airborne structure is configured for continuous operation across aerial, maritime, or transitional environments.
6. The aerial service node of claim 1, wherein the control engine autonomously delivers synthesized energy, communication services, or both to designated recipients without operator intervention.
7. The aerial service node of claim 1, wherein the environmentally coupled energy synthesis assembly operates responsively to environmental availability while maintaining concurrent operation across transduction domains.
8. The aerial service node of claim 1, wherein synthesized energy is transferred to external receivers or storage systems without interrupting ongoing service functions.
9. The distributed aerial service fabric of claim 4, wherein synthesized energy is transferred between nodes to maintain service continuity during localized depletion events.
10. The aerial service node of claim 1, wherein the service continuity bus dynamically reallocates energy resources during fault or instability conditions.
11. The aerial service node of claim 3, wherein the distributed service arbitration subsystem interoperates with terrestrial infrastructure nodes.
12. The aerial service node of claim 3, wherein the distributed service arbitration subsystem interoperates with satellite-based communication endpoints.
13. The aerial service node of claim 3, wherein routing and prioritization are adjusted to preserve latency-sensitive information flows.
14. The aerial service node of claim 3, wherein emergency or authorized traffic is prioritized over non-critical information flows.
15. The aerial service node of claim 1, wherein operational parameters are dynamically optimized when communicatively coupled to external coordination or storage systems.
16. The aerial service node of claim 1, further comprising autonomous safety mechanisms including environmental risk assessment and fault isolation.
17. The aerial service node of claim 1, wherein the sovereign control engine performs predictive environmental modeling to maintain positional stability.
18. The aerial service node of claim 1, wherein the sovereign control engine autonomously repositions the node to maintain service coverage.
19. The aerial service node of claim 2, wherein the radiative conversion domain comprises photovoltaic energy conversion.
20. The aerial service node of claim 2, wherein the fluid-dynamic kinetic conversion domain comprises airflow-driven energy generation.
21. The aerial service node of claim 2, wherein the thermal-gradient conversion domain comprises thermoelectric energy conversion.
22. The aerial service node of claim 2, wherein the mechanically induced charge conversion domain comprises piezoelectric or triboelectric energy conversion.
23. The distributed aerial service fabric of claim 4, wherein a remaining node assumes service responsibility upon loss of another node.
24. The distributed aerial service fabric of claim 4, wherein node positioning is dynamically adjusted to preserve infrastructure-grade service coverage.
25. The aerial service node of claim 1, wherein energy synthesis, service delivery, communication arbitration, positional stability, and resource transfer operations are executed concurrently without mutual exclusion or degradation.
26. The aerial service node of claim 1, wherein the node remains operational on a continuous basis without scheduled downtime.
27. The aerial service node of claim 1, wherein the node maintains continuous operation through autonomous environmental energy harvesting sufficient to sustain all onboard systems without external refueling.
28. The aerial service node of claim 1, wherein the node interfaces with legacy power or communication infrastructure as an augmentation or replacement service endpoint.
29. The distributed aerial service fabric of claim 4, wherein coordination among nodes optimizes aggregate energy availability and information flow across the fabric.
30. The aerial service node of claim 3, wherein the distributed service arbitration subsystem supports simultaneous communication with terrestrial networks and orbital communication systems

### Fallback Embodiments

Various simplified or specialized embodiments of the Forta Halo are contemplated to address cost-sensitive or constrained use cases, without departing from the core inventive concepts:
a. Single-Mode Halo: A simplified variant configured with only one primary energy harvesting modality (e.g. wind-only or solar-only) for situations where full multi-modal capability is unnecessary. This trade-off reduces complexity and cost while still providing the essential functionality needed for a specific application.
b. Ground-Based Halo Variant: A version of the system that operates on a stationary platform(ground-or building-mounted) using the same multi-modal harvesting and communication technologies, for locales where flight is impractical. (For example, this could involve a rotatable dome structure employing Halo subsystems without the buoyant lift components.)
c. Non-Swarm Standalone Variant: A Halo unit operating entirely independently, without swarm coordination or Nexus integration. This variant carries ali necessary control and storage on board and is suited for deployments where network links are unreliable, not permitted, or not desired (e.g., dueto regulatory constraints on inter-unit communications).
d. Manual Redistribution Variant: A configuration in which the normality autonomous background handshake protocol is disabled, and any resource offloading is triggered manually or on a fixed schedule. This mode might be used in early testing phases or in deployments where integration with the secure storage network (Forta Vault) is not available or deliberately turned off (for example, due to policy requirements for human oversight of resource transfers).
e. Partial Alternating Harvesting Variant: An implementation where the device does not harvest ali modalities simultaneously, but rather switches between energy sources based on a priority or time schedule (for example, focusing on solar at midday and wind at night). This approach reduces concurrent subsystem load and simplifies power management, at the cost of lower total energy yield.
f. Basic Communication Variant: A simplified communication model that omits the lattice-basedquantum-safe encryption and uses standard encryption protocols. This variant is intended for regions or uses where post-quantum security is not a concern, orto reduce computational load and hardware cost.
   13g. No Hydrogen Generation Variant: A version that does not include the water electrolysis and hydrogen production subsystem. This “basic climate” model might perform atmospheric water harvesting for immediate use (e.g. firefighting or potable water supply) but not store or convert it to hydrogen, reducing complexity for deployments that do not require hydrogen fuel or lift capabilities.
h. Standard Shell Variant: A cost-reduced model using a conventional durable shell without the self-healing property. This variant trades automated repair capability for lower manufacturing cost, requiring periodic manual inspection or maintenance to address wear and tear.

Each of the above fallback or scaled-down embodiments retains the core inventive concept of multi-modal harvesting and/or autonomous operation but omits or simplifies certain advanced features (such as quantum-safe communications, hydrogen fuel generation, adaptive self-healing, or full-spectrum energy harvesting) to suit specific deployment needs, budget constraints, or regulatory requirements.

These embodiments demonstrate the flexibility of the system to be deployed in a range of configurations while still benefiting from the novel integration of functionalities described herein.

### CONCLUSION

The Forta Halo system establishes a new paradigm of airborne infrastructure by integrating buoyant multi-modal energy harvesting, climate intervention capabilities, swarm intelligence with autonomous AI control, and encrypted autonomous resource redistribution into a single platform. By addressing key weaknesses in prior art—including reliance on single energy sources, lack of adaptability, vulnerability to grid outages, and insecure communications—the Halo presents a unique, patentable solution with broad applications across renewable energy, telecommunications, environmental management, and disaster resilience. The invention operates continuously and independently, optimizing its performance via onboard and networked AI, while remaining compatible with existing infrastructure and regulatory frameworks. Accordingly, the above description and accompanying claims are intended to illustrate the invention without limiting it, and various modifications and equivalent configurations are possible without departing from the scope of the innovation.

1. An autonomous aerial service node, comprising:
(a) an airborne platform configured for persistent station-keeping within an aerial environment without reliance on ground-based power delivery, tethering, propulsion-based point-to-point navigation, or fixed structural support;
(b) an energy harvesting assembly comprising a plurality of distinct environmental energy conversion systems configured to concurrently convert ambient environmental inputs into electrical energy sufficient to sustain continuous operation of the node;
(c) a power distribution system configured to allocate the electrical energy to one or more subsystems including communication, control, storage, or external energy delivery; and
(d) a control system comprising one or more processors and memory storing instructions that, when executed, cause the node to:
(i) maintain a stable operational position relative to a surrounding environment,
(ii) regulate energy harvesting and distribution in response to real-time environmental conditions, and
(iii) provide continuous electrical power, data communication, or infrastructure support services to one or more external systems,
wherein the node operates as a persistent aerial infrastructure unit rather than a mobile aerial vehicle or payload transport system designed for point-to-point movement, and
wherein the energy harvesting assembly, power distribution system, and control system operate interdependently to maintain uninterrupted operation of the node in the absence of ground-based support systems.

2. The aerial service node of claim 1, wherein the plurality of environmental energy conversion systems includes:
(a) a photovoltaic energy conversion system;
(b) an airflow-driven kinetic energy conversion system;
(c) a thermoelectric energy conversion system; and
(d) a mechanically induced electrical charge generation system;
wherein the systems operate concurrently to maintain electrical output under varying environmental conditions.

3. The aerial service node of claim 1, further comprising a communication system configured to:
(a) transmit and receive data between the node and one or more external devices;
(b) dynamically route data based on network demand; and
(c) prioritize selected communication traffic based on predefined criteria.

4. A distributed aerial infrastructure system comprising:
(a) a plurality of aerial service nodes according to claim 1; and
(b) a communication link between at least two of the nodes;
wherein each node is configured to:
(i) exchange operational data with at least one other node; and
(ii) autonomously adjust at least one of energy distribution, communication routing, or spatial positioning relative to environmental conditions to maintain continuous infrastructure service upon degradation or loss of another node. Dependent Claims

5. The aerial service node of claim 1, wherein the airborne platform is configured for persistent deployment over land, water, or combinations thereof.

6. The aerial service node of claim 1, wherein the control system autonomously manages energy delivery without human intervention.

7. The aerial service node of claim 1, wherein the energy harvesting assembly operates continuously across multiple environmental conditions.

8. The aerial service node of claim 1, wherein electrical energy is transmitted to an external receiver while maintaining operation of onboard subsystems.

9. The distributed aerial infrastructure system of claim 4, wherein electrical energy is transferred between nodes to maintain service continuity.

10. The aerial service node of claim 1, wherein the power distribution system reallocates electrical energy in response to detected faults or changes in subsystem demand.

11. The aerial service node of claim 3, wherein the communication system interfaces with terrestrial communication networks.

12. The aerial service node of claim 3, wherein the communication system interfaces with satellite-based communication systems.

13. The aerial service node of claim 3, wherein routing is adjusted to maintain low-latency communication.

14. The aerial service node of claim 3, wherein selected communications are prioritized based on predefined criteria including urgency or system demand.

15. The aerial service node of claim 1, wherein operational parameters are dynamically adjusted based on received external data.

16. The aerial service node of claim 1, further comprising a safety system configured to detect environmental hazards and isolate faults.

17. The aerial service node of claim 1, wherein the control system predicts environmental conditions to maintain positional stability.

18. The aerial service node of claim 1, wherein the control system adjusts position within a bounded operational zone without performing point-to-point navigation.

19. The aerial service node of claim 2, wherein the photovoltaic system comprises one or more solar panels.

20. The aerial service node of claim 2, wherein the airflow-driven system comprises one or more turbines.

21. The aerial service node of claim 2, wherein the thermoelectric system comprises a temperature differential generator.

22. The aerial service node of claim 2, wherein the mechanically induced system comprises a piezoelectric or triboelectric generator.

23. The distributed aerial infrastructure system of claim 4, wherein a remaining node assumes service responsibility upon loss of another node.

24. The distributed aerial infrastructure system of claim 4, wherein node positions are dynamically adjusted to maintain coverage within a defined service region.

25. The aerial service node of claim 1, wherein subsystems operate concurrently without interruption or mutual exclusion.

26. The aerial service node of claim 1, wherein the node is configured for continuous operation without scheduled downtime.
